(19) United States
(12) Patent Application Publication
(10) Pub. No.: US 2025/0364004 A1
(43) Pub. Date: Nov. 27, 2025

(54) AUDIO PROCESSING METHOD AND APPARATUS, STORAGE MEDIUM, AND ELECTRONIC DEVICE

(71) Applicant: Beijing Zitiao Network Technology Co., Ltd., Beijing (CN)

(72) Inventors: Chao HE, Beijing (CN); Peng WANG, Beijing (CN); Hua GAO, Beijing (CN); Yijian XIAO, Beijing (CN)

(21) Appl. No.: 19/199,679

(22) Filed: May 6, 2025

(30) Foreign Application Priority Data
May 24, 2024 (CN) 202410658584.5

(51) Int. Cl. G10L 21/0224; G10L 21/0208; G10L 21/0216; H04B 17/309

(52) U.S. Cl. CPC G10L 21/0224; H04B 17/346; G10L 2021/02082; G10L 2021/02163

(57) ABSTRACT

An audio processing method and apparatus, a storage medium, and an electronic device. The method includes: determining a first residual signal in a current time frame; determining misadjustment change data in the current time frame based on the first residual signal in the current time frame and a reference signal in the current time frame, and determining misadjustment change energy in the current time frame based on the misadjustment change data in the current time frame and misadjustment change data in at least one historical time frame; and obtaining prior misadjustment energy in the current time frame based on the misadjustment change energy in the current time frame and posterior misadjustment energy in a previous time frame, where the prior misadjustment energy in the current time frame is used to update a coefficient of an adaptive filter.

### CROSS-REFERENCE

The present application claims priority to Chinese Patent Application No. 202410658584.5, filed on May 24, 2024, and the disclosure of the above Chinese patent application is incorporated herein by reference in its entirety as part of the present application.

### TECHNICAL FIELD

Embodiments of the present disclosure relate to audio processing technologies, and in particular, to an audio processing method and apparatus, a storage medium, and an electronic device.

### BACKGROUND

In the field of real-time audio and video communication, echo cancellation is a core stage of audio information processing. An echo is generated because there is an acoustic loop between a speaker and a microphone and sound from the speaker may be acquired by the microphone. An echo often severely affects normal phone calls, and echo cancellation is an important step for improving quality of real-time audio and video communication.

Currently, echo cancellation may be implemented through Kalman filtering. However, echo cancellation effects are not so significant in a large reverberation scenario due to echo path variability and other problems, which causes poor quality of real-time audio and video communication.

### SUMMARY

The present disclosure provides an audio processing method and apparatus, a storage medium, and an electronic device, to improve accuracy of updating a filter during an echo cancellation process and improve quality of real-time audio and video communication.

According to a first aspect, an embodiment of the present disclosure provides an audio processing method. The method includes:
determining a first residual signal in a current time frame, where the first residual signal in the current time frame is obtained based on a first echo signal in the current time frame and a near-end signal in the current time frame, and the first echo signal in the current time frame is obtained by performing echo estimation on a reference signal in the current time frame via an adaptive filter;
determining misadjustment change data in the current time frame based on the first residual signal in the current time frame and the reference signal in the current time frame, and determining misadjustment change energy in the current time frame based on the misadjustment change data in the current time frame and misadjustment change data in at least one historical time frame; and
obtaining prior misadjustment energy in the current time frame based on the misadjustment change energy in the current time frame and posterior misadjustment energy in a previous time frame, where the prior misadjustment energy in the current time frame is used to update a coefficient of the adaptive filter.

According to a second aspect, an embodiment of the present disclosure further provides an audio processing apparatus. The apparatus includes:
an audio signal processing module, configured to determine a first residual signal in a current time frame, where the first residual signal in the current time frame is obtained based on a first echo signal in the current time frame and a near-end signal in the current time frame, and the first echo signal in the current time frame is obtained by performing echo estimation on a reference signal in the current time frame via an adaptive filter; and
a filter update module, configured to determine misadjustment change data in the current time frame based on the first residual signal in the current time frame and the reference signal in the current time frame, determine misadjustment change energy in the current time frame based on the misadjustment change data in the current time frame and misadjustment change data in at least one historical time frame, and obtain prior misadjustment energy in the current time frame based on the misadjustment change energy in the current time frame and posterior misadjustment energy in a previous time frame, where the prior misadjustment energy in the current time frame is used to update a coefficient of the adaptive filter.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the audio processing method according to any embodiment of the present disclosure.

According to a fourth aspect, an embodiment of the present disclosure further provides a storage medium including computer-executable instructions, where the computer-executable instructions, when executed by a computer processor, are used to perform the audio processing method according to any embodiment of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic diagram of an echo cancellation process according to an embodiment of the present disclosure;

FIG. 2 is a schematic flowchart of an audio processing method according to an embodiment of the present disclosure;

FIG. 3 is a flowchart of an audio processing method according to an embodiment of the present disclosure;

FIG. 4 is a flowchart of an audio processing method according to an embodiment of the present disclosure;

FIG. 5 is a schematic diagram of a structure of an audio processing apparatus according to an embodiment of the present disclosure; and

FIG. 6 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

Application scenarios of real-time audio and video communication include, but are not limited to, an audio and video conference scenario, etc. During the above real-time communication process, an electronic device for communication is configured with a speaker for playing a received audio signal and a microphone for acquiring a near-end signal in an environment, where the near-end signal may include a voice signal from a real-time communicator, an ambient noise signal, and an echo signal formed when the speaker plays the audio signal. Echo estimation is performed via an adaptive filter with the received audio signal as a reference signal, to obtain the echo signal, and the echo signal is removed from the near-end signal to obtain a residual signal. The residual signal may be used as an output signal of the real-time communication device.

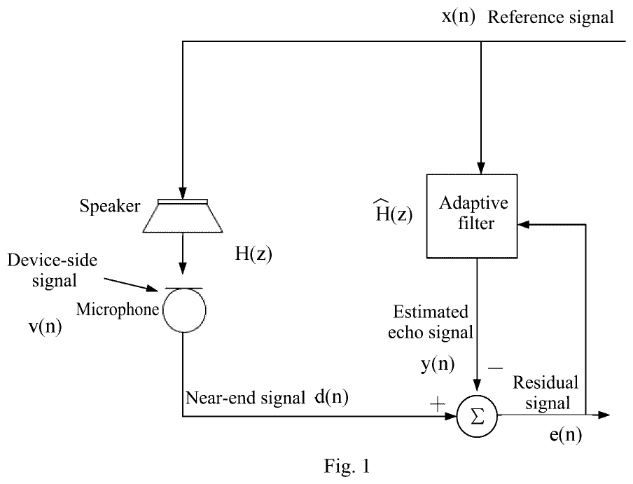

Referring to FIG. 1, FIG. 1 is a schematic diagram of an echo cancellation process according to an embodiment of the present disclosure. In the figure, x(n) is the reference signal, H(z) represents a transfer function for an echo path from the speaker to the microphone, Ĥ(z) represents the adaptive filter, d(n) is the near-end signal acquired by the microphone, v(n) is the voice signal input by the real-time communicator, y(n) is the echo signal estimated via the adaptive filter, and e(n) is the residual signal obtained via the adaptive filter through a filtering process, where n is a time frame index.

Here, the adaptive filter may be a Kalman filter. A noise signal is estimated based on a principle of minimizing a system misadjustment during the process of filtering the audio signal via the Kalman filter, where the noise signal may be understood as the echo signal.

In a defined state equation and observation equation of the adaptive filter:

$$\begin{matrix}D ( n , k ) \approx {X}^{T} ( n , k ) + {H}^{*} ( n , k ) + V ( n , k ) ; and \\ H ( n , k ) = H ( n - 1 , k ) + W ( n , k ) . \\ Here , X ( n , k ) = [ X ( n , k ) , X ( n - 1 , k ) … , X ( n - L + 1 , k ) ] ; and \\ H ( n , k ) = [ H ( 0 , k ) , H ( 1 , k ) , … , H ( L - 1 , k ) ] .\end{matrix}$$

L is a filter order (also referred to as a filter length), which is set by a user. D(n, k) is the near-end signal acquired by the microphone. X(n, k) and H(n, k) indicate short-time Fourier transform (STFT) vectors of the reference signal and a filter coefficient of an echo path filter, respectively. W(n, k) is a change in a coefficient of the adaptive filter after each iteration. The superscript * indicates complex conjugate. The superscript T indicates vector transpose. A bold variable indicates a vector, and a non-bold variable indicates a scalar.

The system misadjustment may be understood as a difference between an actual echo path and an echo path estimated via the adaptive filter. The system misadjustment includes a posterior misadjustment and a prior misadjustment. The prior misadjustment is a difference between the actual echo path in a current time frame and an echo path that is estimated in a previous time frame via the adaptive filter. The posterior misadjustment is a difference between the actual echo path in the current time frame and an echo path that is estimated in the current time frame via the adaptive filter.

A state misadjustment vector and a covariance matrix thereof are defined as follows:

$$\begin{matrix}μ ( n , k ) = H ( n , k ) - \hat{H} ( n , k ) \\ {R}_{μ} ( n , k ) = E [ μ ( n , k ) {μ}^{T} ( n , k ) ] ; \\ m ( n , k ) = H ( n , k ) - \hat{H} ( n - 1 , k ) ; and \\ {R}_{m} ( n , k ) = E [ m ( n , k ) {m}^{T} ( n , k ) ] .\end{matrix}$$

A covariance Rμ(n, k) of the posterior misadjustment μ(n, k) may be understood as posterior misadjustment energy. A covariance Rₘ(n, k) of the prior misadjustment m(n, k) may be understood as prior misadjustment energy. The posterior misadjustment μ(n, k) is a difference between an impulse response of the echo path at an nth sampling moment and an impulse response of the filter at the n^{th} sampling moment. The prior misadjustment m(n, k) is a difference between the impulse response of the echo path at the n^{th} sampling moment and an impulse response of the filter at an (n−1)^{th} sampling moment. E indicates taking a mathematical expectation.

H(n, k) indicates a transfer function for the actual echo path, Ĥ(n, k) indicates a transfer function for the echo path estimated via the adaptive filter, n is the time frame index, and k is a frequency index.

If the prior misadjustment and the posterior misadjustment degrade from a matrix to a scalar, a covariance of W(n, k) corresponding thereto may be

$${R}_{W} ( n , k ) = E [ {W}^{T} ( n , k ) W ( n , k ) ] = {\hat{σ}}_{w}^{2} ( n , k ) , where {\hat{σ}}_{w}^{2} ( n , k )$$

is time-varying information of the echo path. In this case, the covariance of the prior misadjustment is

$${R}_{m} ( n , k ) = {R}_{μ} ( n - 1 , k ) + {R}_{W} ( n , k ) = {R}_{μ} ( n - 1 , k ) + {\hat{σ}}_{w}^{2} ( n , k ) .$$

It can be understood that the covariance Rₘ(n, k)=R_{μ}(n−1, k)+R_{W}(n, k) of the above prior misadjustment is an ideal iterative formula for the misadjustment. During an actual misadjustment calculation process, the actual echo path is unknown, and attempts are made during each iteration process, to approximate to the actual echo path. Therefore, the prior misadjustment is updated during an actual iteration process according to Rₘ(n, k)=R_{μ}(n−1, k)+R_{W}(n−1, k).

It is mainly assumed in conventional adaptive filtering that the path remains unchanged or varies not so drastically over time. In this case, the update of the prior misadjustment can find a minimum-error solution even if the path varies over time. However, if the path varies drastically over time, estimating a future path based only on the previous time frame may cause a sharp change in the misadjustment, while a predicted misadjustment is small, making it impossible to prevent from echo leakage.

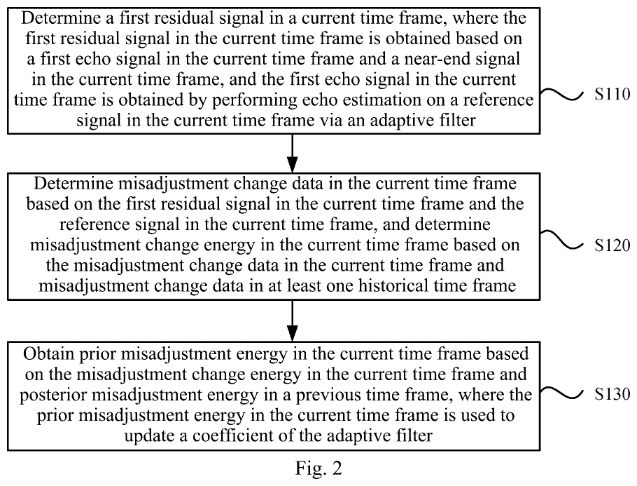

A cause for a sudden change in the echo path includes, but is not limited to, a change in the communication environment, switching of a component such as the microphone of the communication device, an abnormality in processing of the audio signal by the communication device, and the like. An embodiment of the present disclosure provides an audio processing method for the above problem of poor echo cancellation effects caused by the sudden change in the echo path. Referring to FIG. 2, FIG. 2 is a schematic flowchart of an audio processing method according to an embodiment of the present disclosure. This embodiment of the present disclosure is applicable to a case in which misadjustment iteration is performed based on misadjustment change data in a time frame during echo cancellation performed on audio information via a Kalman filter, to improve accuracy of echo path estimation. The method may be performed by an audio processing apparatus. The apparatus may be implemented in the form of software and/or hardware, optionally by an electronic device. The electronic device may be a mobile terminal, a PC, a server, etc.

As shown in FIG. 2, the method includes the following steps.
S110: Determining a first residual signal in a current time frame, where the first residual signal in the current time frame is obtained based on a first echo signal in the current time frame and a near-end signal in the current time frame, and the first echo signal in the current time frame is obtained by performing echo estimation on a reference signal in the current time frame via an adaptive filter.
S120: Determining misadjustment change data in the current time frame based on the first residual signal in the current time frame and the reference signal in the current time frame, and determining misadjustment change energy in the current time frame based on the misadjustment change data in the current time frame and misadjustment change data in at least one historical time frame.
S130: Obtaining prior misadjustment energy in the current time frame based on the misadjustment change energy in the current time frame and posterior misadjustment energy in a previous time frame, where the prior misadjustment energy in the current time frame is used to update a coefficient of the adaptive filter.

During a real-time audio and video communication process, a real-time communication device receives, in real time, the reference signal X(n, k) in the current time frame, and the near-end signal D(n, k) in the current time frame that is acquired by a microphone, and filters the near-end signal in the current time frame based on the reference signal in the current time frame via the adaptive filter obtained through update during a historical iteration process, to obtain the first residual signal. Specifically, echo estimation is performed on the reference signal in the current time frame via the adaptive filter, to obtain the first echo signal in the current time frame, and the first residual signal in the current time frame is obtained based on a difference between the near-end signal in the current time frame and the first echo signal in the current time frame. For example, the first residual signal in the current time frame is E(n, k)=D(n, k)−X^{T}(n, k)Ĥ*(n−1, k), where Ĥ(n−1, k) is a coefficient of the adaptive filter obtained through update during the historical iteration process. In some embodiments, the first residual signal may be used as an output audio signal of the real-time communication device.

The misadjustment change data in the current time frame may represent a path change in the current time frame. Path changes in a plurality of time frames may be accumulated based on the misadjustment change data in the current time frame and the misadjustment change data in the at least one historical time frame, to improve accuracy of a misadjustment. Accordingly, accuracy of updating the coefficient of the adaptive filter is improved during the process of updating the coefficient of the adaptive filter.

A misadjustment estimated in each iteration is |w_{old}(n)|²=|ĥ(n−1)−ĥ(n−2)|² in time domain. Here, h(n−1) is a filter coefficient estimated in a time frame n−1, and a filter coefficient estimated in a previous frame is used to update a misadjustment in the current time frame n. In order to improve the accuracy of the misadjustment, the misadjustment in the current time frame may be estimated by using information in the current time frame. Here, w_{old}(n) represents misadjustment change data corresponding to the time frame n.

Assuming that there is a true filter coefficient h, the misadjustment is |wₜᵤᵣₑ(n)|₂=|hₜᵤᵣₑ(n)−ĥ(n−2)|² in time domain. Since the adaptive filter is updated in real time, the true filter coefficient h is replaced with current information, that is, ĥ(n) may gradually approximate to hₜᵤᵣₑ(n). Accordingly, |wₜᵤᵣₑ(n)|²=|ĥ(n)−ĥ(n−2)|².

On the basis of the above formula, it can be learned from an iterative formula of the adaptive filter that: ĥ(n)=h(n)+w(n); and ĥ(n−2)=h(n−1). Here, h(n) is a filter coefficient corresponding to the time frame n. A filter coefficient estimated for a time frame n−2 may be used as a filter coefficient corresponding to a time frame n−1.

It can be learned from all the above formulas that: |wₜᵤᵣₑ(n)|²=|ĥ(n)−h(n−1)|²; and |wₜᵤᵣₑ(n)|²=|h(n)−h(n−1)+w(n)|²=|w(n)+w(n−1)|².

Further, a misadjustment obtained through m iteration processes is

$${\vert {w}_{ture} ( n ) \vert}^{2} = {\vert {\sum }_{i = 0}^{m} w ( n - i ) \vert}^{2}$$

in time domain, where m is greater than or equal to 1.

It can be learned from the above derivation process that misadjustment change data in a plurality of time frames may be accumulated to approximate to true misadjustment change data, to improve the accuracy of the misadjustment. In other words, the misadjustment in the current time frame is obtained by iteratively combining the misadjustment change data in the current time frame and the misadjustment change data in the historical time frame.

For the current time frame, the misadjustment change data in the current time frame is determined, and the misadjustment change data in the historical time frame is read to update the misadjustment in the current time frame. In some embodiments, in order to consider the accuracy of the misadjustment and also reduce a computational amount, the misadjustment in the current time frame is updated based on misadjustment change data respectively corresponding to a preset number of time frames. For example, the misadjustment in the current time frame is updated based on the misadjustment change data in the current time frame and misadjustment change data in the previous time frame.

Optionally, the misadjustment change data in the current time frame is determined based on the first residual signal in the current time frame and the reference signal in the current time frame. For example, the misadjustment change data in the current time frame is determined in the following manner: determining initial prior misadjustment energy in the current time frame based on the posterior misadjustment energy in the previous time frame and misadjustment change energy in the previous time frame; obtaining near-end estimated energy in the current time frame based on the initial prior misadjustment energy in the current time frame and the reference signal in the current time frame; determining a first step size based on the near-end estimated energy in the current time frame and the initial prior misadjustment energy in the current time frame; and determining the misadjustment change data in the current time frame based on the first step size, the first residual signal in the current time frame, and the reference signal in the current time frame.

The posterior misadjustment energy may be represented by a covariance of a posterior misadjustment. The misadjustment change energy may be represented by a covariance of a misadjustment change. The prior misadjustment energy may be represented by a covariance of the prior misadjustment.

The misadjustment change data in the current time frame may be calculated through the following process:

$${R}_{m} ( n , k ) = {R}_{μ} ( n - 1 , k ) + {R}_{W} ( n - 1 , k ) ; \\ {R}_{e} ( n , k ) = {X}^{H} ( n , k ) {R}_{m} ( n , k ) X ( n , k ) + {\hat{σ}}_{v}^{2} ( n , k ) ; \\ u ( n , k ) = \frac{{R}_{m} ( n , k )}{{R}_{e} ( n , k )} ; \\ and \\ w ( n , k ) = \sum u ( n , k ) * conj ( E ( n , k ) ) * X ( n , k ) .$$

R_{μ}(n−1, k) is the posterior misadjustment energy in the previous time frame n−1. R_{W}(n−1, k) is the misadjustment change energy in the previous time frame n−1. The initial prior misadjustment energy in the current time frame is determined based on a sum of the posterior misadjustment energy in the previous time frame n-1 and the misadjustment change energy in the previous time frame n−1. Rₑ(n, k) is the near-end estimated energy in the current time frame. u(n, k) is the first step size, and is determined based on a ratio of the initial prior misadjustment energy in the current time frame to the near-end estimated energy in the current time frame. conj is a conjugate function. w(n, k) is the misadjustment change data in the current time frame, and is determined based on a cumulative sum of products of the conjugate function for the first residual signal, the first step size, and the reference signal at a plurality of orders.

In each historical time frame, misadjustment change data in the historical time frame is stored, and the misadjustment change data in the historical time frame is read. The misadjustment change energy in the current time frame may be obtained based on the misadjustment change data in the current time frame and the misadjustment change data in the historical time frame.

For example, the misadjustment change energy in the current time frame may be represented as

$${R}_{W} ( n , k ) = {\vert {\sum }_{i = 0}^{m} w ( n - i , k ) \vert}^{2} ,$$

that is, is determined based on the sum of the misadjustment change data in the current time frame and the misadjustment change data in the historical time frame.

In some embodiments, the misadjustment change energy in the current time frame is determined based on the sum of the misadjustment change data in the current time frame and the misadjustment change data in the previous time frame. Accordingly, the misadjustment change energy in the current time frame may be represented as R_{W}(n, k)=|w(n, k)+w(n−1, k)|².

The prior misadjustment energy in the current time frame is obtained based on the misadjustment change energy in the current time frame and the posterior misadjustment energy in the previous time frame. For example, the prior misadjustment energy in the current time frame is obtained based on the sum of the misadjustment change energy in the current time frame and the posterior misadjustment energy in the previous time frame. For example, the prior misadjustment energy in the current time frame is Rₘ(n, k)=R_{μ}(n−1, k)+R_{W}(n, k).

The misadjustment change energy in the current time frame is added to the posterior misadjustment energy in the previous time frame. Compared with predicting posterior misadjustment energy in the current time frame by using only the data in the historical time frame, it improves accuracy of updating the misadjustment by using the change data in the current time frame as a basis.

The prior misadjustment energy in the current time frame is used to update the coefficient of the adaptive filter in the current time frame. The coefficient of the adaptive filter may be updated through the following process:

$${R}_{e} ( n , k ) = {X}^{H} ( n , k ) {R}_{m} ( n , k ) X ( n , k ) + {\hat{σ}}_{v}^{2} ( n , k ) ; \\ u ( n , k ) = \frac{{R}_{m} ( n , k )}{{R}_{e} ( n , k )} ; \\ K ( n , k ) = {R}_{m} ( n , k ) {X ( n , k ) [ {R}_{e} ( n , k ) ]}^{- 1} ; \\ \hat{H} ( n , k ) = \hat{H} ( n - 1 , k ) + K ( n , k ) {E}^{*} ( n , k ) ; \\ and \\ {R}_{μ} ( n , k ) = [ 1 - \frac{u ( n , k ) {X}^{H} ( n , k ) * X ( n , k )}{L} ] {R}_{m} ( n , k ) .$$

K(n, k) is a coefficient gain in the current time frame. R_{μ}(n, k) is a posterior misadjustment in the current time frame.

According to the technical solution in this embodiment of the present disclosure, during an iteration process in each time frame, prior misadjustment energy in the current time frame is obtained through inference based on misadjustment change data in the current time frame and misadjustment change data in a historical time frame. In other words, the prior misadjustment energy in each time frame is obtained through inference based on a path change between the current time frame and the historical time frame, instead of inference based only on a path in the historical time frame. Therefore, the prior misadjustment energy in each time frame is highly accurate. Accordingly, a coefficient of the adaptive filter corresponding to each time frame is obtained through update based on the highly accurate prior misadjustment energy, so that accuracy of the coefficient of the adaptive filter is improved, and audio processing accuracy is further improved.

On the basis of the above embodiment, during a process of determining the prior misadjustment energy in the current time frame and during a process of updating the coefficient of the adaptive filter, the method further includes: partitioning a solution matrix, where the solution matrix includes a reference signal matrix, a prior misadjustment energy matrix, a posterior misadjustment energy matrix, a step size matrix, etc.

The process of filtering the near-end signal via the adaptive filter involves a large number of matrix multiplications, and formula processing for the matrix multiplications results in the problems of a larger computational amount, high computing power consumption, and low filtering efficiency. Currently, there are attempts to simplify a filtering formula. A current simplification manner is converting matrices into scalars, which reduces the number of multiplications from L*L to 1. Excessive reduction of the computational amount affects the filtering effects of the adaptive filter. Conversion of misadjustment energy (covariance) into a scalar during compensation of the adaptive filter makes a step size at each order the same. In a large reverberation scenario, the order of the adaptive filter is high, and the same step size unifies the update at each order, but results in an excessively great cumulative error of the adaptive filter at an echo tail length due to the fact that there is no need for excessive updates, thereby affecting the filtering effects of the adaptive filter in the large reverberation scenario.

In this embodiment, the solution matrix is partitioned, and the solution matrix is converted into a vector, to reduce the computational amount and adapt a step size required for each order. The number of the multiplications in the calculation process is reduced from L*L to blockL*1 by partitioning the solution matrix, where blockL indicates an order length of each block.

For example, the prior misadjustment energy in the current time frame may be determined through the following process:

$${R}_{m} ( n , k , l ) = {R}_{μ} ( n - 1 , k , l ) + {R}_{W} ( n - 1 , k , l ) ; \\ {R}_{e} ( n , k ) = {\sum }_{l = 0}^{b} {X}^{H} ( n , k , l ) {R}_{m} ( n , k , l ) X ( n , k , l ) + {\hat{σ}}_{v}^{2} ( n , k ) ; \\ u ( n , k , l ) = \frac{{R}_{m} ( n , k , l )}{{R}_{e} ( n , k )} ; \\ w ( n , k , l ) = {\sum }_{l = 0}^{b} \sum u ( n , k , l ) * conj ( E ( n , k ) ) * X ( n , k , l ) ; \\ {R}_{W} ( n , k , l ) = {\vert w ( n , k , l ) + w ( n - 1 , k , l ) \vert}^{2}$$

and Rₘ(n, k, l)=R_{μ}(n−1, k, l)+R_{W}(n, k, l), where I represents any block, and b is the total number of the blocks.

For example, the coefficient of the adaptive filter may be updated through the following process:

$${R}_{e} ( n , k , l ) = {\sum }_{l = 0}^{b} {X}^{H} ( n , k , l ) {R}_{m} ( n , k , l ) X ( n , k , l ) + {\hat{σ}}_{v}^{2} ( n , k ) ; \\ u ( n , k , l ) = \frac{{R}_{m} ( n , k , l )}{{R}_{e} ( n , k )} ; \\ K ( n , k , l ) = u ( n , k , l ) X ( n , k , l ) ; \\ \hat{H} ( n , k ) = \hat{H} ( n - 1 , k ) + {\sum }_{l = 0}^{b} K ( n , k , l ) {E}^{*} ( n , k ) ; \\ {R}_{μ} ( n , k , l ) = [ 1 - \frac{u ( n , k , l ) {X}^{H} ( n , k , l ) * X ( n , k , l )}{BLOCKL} ] {R}_{m} ( n , k , l ) ; \\ and \\ {R}_{W} ( n , k , l ) = \frac{{\sum }_{t = 0}^{b} K ( n , k , l ) {E}^{*} ( n , k )}{BLOCKL} .$$

According to the technical solution in this embodiment, the solution matrix is partitioned during the adaptive filtering process, to simplify calculation in the filtering process, so that impact of excessive simplification on the filtering effects is avoided on the basis of reducing the computational amount.

On the basis of the above embodiment, an iteration direction of the adaptive filter may deviate during an iterative updating process of the adaptive filter, which makes the coefficient of the adaptive filter inaccurate, affecting the filtering effects of the adaptive filter. In order to avoid an inaccurate filter coefficient which affects the accuracy of a residual signal during an iterative updating process of a single adaptive filter, a shadow filter and/or a backup filter is provided to filter the near-end signal, and the residual signal obtained via the adaptive filter is verified based on a residual signal obtained via the shadow filter and/or the backup filter through filtering, to improve the accuracy of the residual signal obtained via the adaptive filter. Optionally, the shadow filter and the backup filter may each be a Kalman filter.

In some embodiments, echo estimation is performed on the reference signal in the current time frame based on the shadow filter, to obtain a second echo signal in the current time frame, and a second residual signal is determined based on the second echo signal in the current time frame and the near-end signal in the current time frame. The first residual signal is updated based on the second residual signal when the first residual signal and the second residual signal satisfy a first condition.

The shadow filter is a companion filter to the adaptive filter. A coefficient of the shadow filter is updated in each iteration of the adaptive filter, to correct the coefficient of the adaptive filter. Echo estimation is performed on the reference signal in the current time frame via the adaptive filter and the shadow filter, respectively, to obtain the first echo signal and the second echo signal, respectively. The first echo signal is subtracted from the near-end signal in the current time frame, to obtain the first residual signal in the current time frame. The second echo signal is subtracted from the near-end signal in the current time frame, to obtain the second residual signal in the current time frame. Here, the second residual signal may be obtained in the following manner: E_{shadow}(n, k)=D(n, k)−X^{T}(n, k)Ĥ*_{shadow}(n−1, k), where Ĥ*_{shadow}(n−1, k) is the coefficient of the shadow filter.

The first residual signal and the second residual signal in the current time frame are compared, and the filtering effects of the adaptive filter and the shadow filter are measured based on a result of comparison between the first residual signal and the second residual signal, to represent the accuracy of the iteration direction of the adaptive filter. If the iteration direction of the adaptive filter is accurate, the first residual signal obtained via the adaptive filter is retained; or if the iteration direction of the adaptive filter deviates, the first residual signal is updated based on the second residual signal obtained via the shadow filter, for example, the second residual signal is used as the first residual signal, and the original first residual signal is discarded.

When the first residual signal and the second residual signal satisfy the first condition, it indicates that the filtering effects of the shadow filter are better than those of the adaptive filter. The first condition is used to measure a difference between the first residual signal and the second residual signal. Optionally, the first condition may be that a ratio of the first residual signal to the second residual signal is greater than a first value, that is, the first residual signal is greater than a product of the second residual signal and the first value. Here, the first value may be set based on a judging requirement. Optionally, the first value is greater than 1, for example, may be 1.1.

For example, an update process of the first residual signal may be represented as follows:

$$E ( n , k ) = \{ \begin{matrix}{E}_{shadow} ( n , k ) , if E ( n , k ) > a * {E}_{shadow} ( n , k ) \\ E ( n , k ) , else\end{matrix} ,$$

When the first residual signal and the second residual signal satisfy the first condition, it indicates that the coefficient of the adaptive filter involves inaccuracy in the update process. In order to avoid a wrong iteration direction, the coefficient of the adaptive filter is updated based on the coefficient of the shadow filter. Specifically, the coefficient of the adaptive filter may be replaced with the coefficient of the shadow filter.

When the first residual signal and the second residual signal do not satisfy the first condition, it indicates that the filtering effects of the adaptive filter are better than those of the shadow filter, that is, the iteration direction of the coefficient of the adaptive filter is accurate, and the coefficient of the adaptive filter is better than that of the shadow filter. The coefficient of the shadow filter is updated based on the coefficient of the adaptive filter, for example, the coefficient of the shadow filter is replaced with the coefficient of the adaptive filter, to implement update of the coefficient of the shadow filter.

For example, a coefficient update process of the adaptive filter and the shadow filter may be represented as follows:

$$\hat{H} ( n - 1 , k ) = {\hat{H}}_{shadow} ( n - 1 , k ) , if E ( n , k ) > a * {E}_{shadow} ( n , k ) ;$$

Ĥ_{shadow}(n−1, k)=(n−1, k), else, where a is the first value.

In this embodiment, the shadow filter is provided, and the filtering process is performed via both the shadow filter and the adaptive filter, to obtain the second residual signal and the first residual signal. When the second residual signal and the first residual signal satisfy the first condition, it indicates that the coefficient of the adaptive filter is updated in a wrong direction, and the first residual signal is updated based on the second residual signal, to ensure accuracy of an updated first residual signal. In addition, the coefficient of the adaptive filter is updated based on the coefficient of the shadow filter, to correct the coefficient which is updated in the wrong direction, so that impact of the wrong iteration direction is reduced.

In some embodiments, echo estimation is performed on the reference signal in the current time frame based on the backup filter, to obtain a third echo signal in the current time frame, and a third residual signal is determined based on the third echo signal in the current time frame and the near-end signal in the current time frame. The first residual signal is updated based on the third residual signal when the first residual signal and the third residual signal satisfy a second condition.

The backup filter is configured to verify a convergence status of the adaptive filter, and assist the adaptive filter in fast convergence when the adaptive filter cannot converge during the iteration.

For example, the backup filter may filter the near-end signal to obtain the third residual signal through the following calculation: E_{backup}(n, k)=D(n, k)−X^{T}(n, k)Ĥ*_{backup}(n−1, k), where Ĥ*_{backup}(n−1, k) is a coefficient of the backup filter.

The first residual signal and the third residual signal are judged based on the preset second condition. The second condition includes that the first residual signal is greater than the near-end signal and the third residual signal is less than the near-end signal. Optionally, a ratio of the third residual signal to the near-end signal is less than a second value. The second value may be a value greater than 1. For example, the second value may be 1.2.

It can be understood that the first residual signal herein may be either a first residual signal output by the adaptive filter or a first residual signal obtained by verifying the second residual signal output by the shadow filter. The first residual signal being greater than the near-end signal indicates that the adaptive filter and/or the shadow filter cannot function as a filter, that is, the adaptive filter and/or the shadow filter cannot achieve much convergence during iterations that have been performed. The third residual signal being less than the near-end signal indicates that the backup filter has specific filtering effects. Therefore, the third residual signal is better than the first residual signal, and the first residual signal is updated based on the third residual signal. For example, the first residual signal is replaced with the third residual signal, and the original first residual signal is discarded.

For example, an update process of the first residual signal may be represented as follows:

$$E ( n , k ) = \{ \begin{matrix}{E}_{backup} ( n , k ) , if E ( n , k ) < D ( n , k ) and {E}_{backup} ( n , k ) < b * D ( n , k ) \\ E ( n , k ) , else\end{matrix} ,$$

where b is the second value.

The first residual signal and the third residual signal are compared based on a preset third condition. The third condition is used to measure a difference between the first residual signal and the third residual signal. The third condition may be that the first residual signal is greater than the third residual signal and the first residual signal is greater than the third residual signal by a multiple of a third value.

When the first residual signal and the third residual signal satisfy the third condition, it indicates that the iteration direction of the adaptive filter deviates, and the coefficient of the adaptive filter is updated based on the coefficient of the backup filter. For example, the coefficient of the adaptive filter is replaced with the coefficient of the backup filter. Iteration continues to be performed on the coefficient of the adaptive filter after the coefficient of the adaptive filter is updated.

A fourth condition is set to judge the filtering effects of the adaptive filter. When the first residual signal satisfies the fourth condition, it indicates that the iteration direction of the adaptive filter is accurate, the coefficient of the adaptive filter is accurate to some extent, and the adaptive filter has good filtering effects. When the first residual signal satisfies the fourth condition, the coefficient of the backup filter is updated based on the coefficient of the adaptive filter, to implement high-quality coefficient update of the backup filter, where a high-quality backup filter provides a high-quality service for a subsequent iteration process.

The fourth condition may be that the first residual signal is less than the near-end signal. Optionally, the fourth condition may alternatively be that a ratio of the first residual signal to the near-end signal is less than a third value.

For example, a coefficient update process of the adaptive filter and the backup filter may be represented as follows:

$$\hat{H} ( n - 1 , k ) = {\hat{H}}_{backup} ( n - 1 , k ) , if E ( n , k ) > c * {E}_{backup} ( n , k ) ;$$

Ĥ_{backup}(n−1, k)=Ĥ(n−1, k), if E(n, k)<b*D(n, k), where c is the third value, and the third value is greater than 1, for example, may be 1.1.

It can be understood that both the shadow filter and the backup filter are initialized, and coefficient update are performed during iteration when specific conditions are satisfied. In this embodiment, the backup filter is provided for assistance when the adaptive filter cannot converge during iteration, instead of directly resetting the filter, so that specific filtering effects can be achieved on the near-end signal, and interference of echo and echo leakage are reduced.

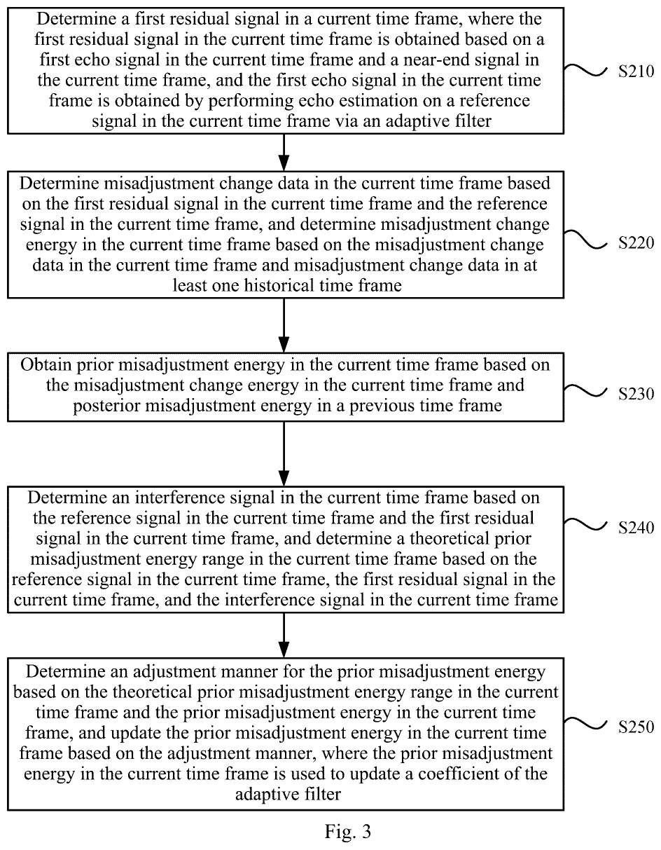

In bad scenarios, near-end signals are in low correlation with reference signals. Since a high-order filter is updated slowly, an actual update step size cannot cover these bad scenarios. For example, a nonlinear problem of a speaker causes fluctuation of amplitudes of some near-end frequency bands and leakage of the near-end frequency bands to adjacent frequency bands. Alternatively, the near-end signals have been pre-processed by using an existing hardware algorithm, resulting in severe random nonlinear damage. In order to improve suppression of the adaptive filter over nonlinearity, it is necessary to accelerate convergence of the adaptive filter. However, excessive acceleration of convergence may increase a misadjustment, causing damage to the near-end signal. The above problem may affect convergence of the adaptive filter. Specific to the above technical problem, FIG. 3 is a flowchart of an audio processing method according to an embodiment of the present disclosure. On the basis of the above embodiment, convergence of the filter is accelerated/decelerated. Referring to FIG. 3, the method specifically includes the following steps.
S210: Determining a first residual signal in a current time frame, where the first residual signal in the current time frame is obtained based on a first echo signal in the current time frame and a near-end signal in the current time frame, and the first echo signal in the current time frame is obtained by performing echo estimation on a reference signal in the current time frame via an adaptive filter.
S220: Determining misadjustment change data in the current time frame based on the first residual signal in the current time frame and the reference signal in the current time frame, and determining misadjustment change energy in the current time frame based on the misadjustment change data in the current time frame and misadjustment change data in at least one historical time frame.
S230: Obtaining prior misadjustment energy in the current time frame based on the misadjustment change energy in the current time frame and posterior misadjustment energy in a previous time frame.
S240: Determining an interference signal in the current time frame based on the reference signal in the current time frame and the first residual signal in the current time frame, and determining a theoretical prior misadjustment energy range in the current time frame based on the reference signal in the current time frame, the first residual signal in the current time frame, and the interference signal in the current time frame.
S250: Determining an adjustment manner for the prior misadjustment energy based on the theoretical prior misadjustment energy range in the current time frame and the prior misadjustment energy in the current time frame, and updating the prior misadjustment energy in the current time frame based on the adjustment manner, where the prior misadjustment energy in the current time frame is used to update a coefficient of the adaptive filter.

In this embodiment, the theoretical prior misadjustment energy range in the current time frame is determined in the current time frame, and the prior misadjustment energy in the current time frame is judged based on the theoretical prior misadjustment energy range in the current time frame, to determine the adjustment manner for a convergence speed of the adaptive filter. The convergence speed of the adaptive filter may be adjusted by adjusting the prior misadjustment energy. For example, the convergence speed of the adaptive filter may be increased by performing accelerated adjustment on the prior misadjustment energy; and the convergence speed of the adaptive filter may be reduced by performing decelerated adjustment on the prior misadjustment energy. In other words, the adjustment manner for the prior misadjustment energy includes accelerated adjustment and decelerated adjustment. On the basis of solving the nonlinear problem, performing accelerated/decelerated adjustment on prior misadjustment energy in each time frame reduces damage to the near-end signal caused by excessively fast convergence.

Assuming that there is a relationship between the prior misadjustment energy and estimated energy of the near-end signal, the relationship may be expressed as follows:

$${R}_{m} ( n , k ) = \frac{Se ( n , k ) - Sv ( n , k )}{\sum {X}^{2} ( n , k )} ,$$

Se(n, k) is residual signal energy in a near-end signal, Sv(n, k) is interference signal energy in the near-end signal, and ΣX²(n, k) represents accumulation of the reference signal on orders, where the residual signal energy may be understood as signal energy corresponding to a first reference signal.

In order to accelerate convergence of the adaptive filter, the interference signal may be estimated based on a correlation between the reference signal and the first residual signal. Optionally, the determining an interference signal in the current time frame based on the reference signal in the current time frame and the first residual signal in the current time frame includes: determining an intermediate signal based on correlation data between the reference signal in the current time frame and the first residual signal in the current time frame, and determining the interference signal in the current time frame based on the intermediate signal and the first residual signal in the current time frame. The correlation data between the reference signal in the current time frame and the first residual signal in the current time frame may be obtained based on a conjugate function of the reference signal in the current time frame and the first residual signal in the current time frame. The intermediate signal is determined based on the correlation data between the reference signal in the current time frame and the first residual signal in the current time frame, and energy of the reference signal. The energy of the reference signal is obtained based on the reference signal and a conjugate function of the reference signal.

For example, the interference signal may be obtained by solving the following formula:

$${V}^{2} ( n , k ) = {E}^{2} ( n , k ) - \frac{{\vert {\sum }_{i < t} ( X ( n , k ) * conj ( E ( n , k ) ) ) \vert}^{2}}{{\sum }_{i < t} ( X ( n , k ) * conj ( X ( n , k ) ) )} ,$$

where i indicates a time frame, and t is the number of time frames for accumulation.

Accordingly, the residual signal energy in the current time frame is determined based on residual signal energy in the previous time frame and the first residual signal in the current time frame, for example, may be obtained through weighting based on the residual signal energy in the previous time frame and an amplitude of the first residual signal in the current time frame. For example, the residual signal energy in the current time frame is calculated in the following manner: Se(n, k)=α*Se(n−1, k)+(1−α)*E²(n, k), where a is a weight.

The interference signal energy in the current time frame is obtained based on interference signal energy in the previous time frame and the interference signal in the current time frame, for example, may be obtained through weighting based on the interference signal energy in the previous time frame and an amplitude of the interference signal in the current time frame. For example, the interference signal energy in the current time frame is calculated in the following manner: Sv(n, k)=β*Sv(n−1, k)+(1−β)*V²(n, k), where β is a weight. α and β may be the same or different.

Accordingly, when Sv(n, k) is zero, theoretical prior misadjustment energy in the current time frame reaches a maximum value. In other words, a maximum value of the theoretical prior misadjustment energy range is determined based on the residual signal energy corresponding to the first residual signal in the current time frame and the reference signal in the current time frame. For example,

$${R}_{m} max ( n , k ) = \frac{Se ( n , k )}{\sum {X}^{2} ( n , k )} .$$

When Sv(n, k) is not zero, a minimum value of the theoretical prior misadjustment energy range is obtained. In other words, an energy difference between the residual signal energy corresponding to the first residual signal in the current time frame and the interference signal energy corresponding to the interference signal in the current time frame is determined, and the minimum value of the theoretical prior misadjustment energy range is determined based on the energy difference and the reference signal in the current time frame. For example,

$${R}_{m} norm ( n , k ) = \frac{Se ( n , k ) - Sv ( n , k )}{\sum {X}^{2} ( n , k )} .$$

Accordingly, the theoretical prior misadjustment energy range is [Rₘnorm(n, k): Rₘmax(n, k)]. Accelerated/decelerated adjustment is performed on the prior misadjustment energy of the adaptive filter within the above theoretical prior misadjustment energy range.

The adjustment manner for the prior misadjustment energy includes accelerated adjustment and decelerated adjustment. An accelerated adjustment determining condition and a decelerated adjustment determining condition are preset. When the prior misadjustment energy in the current time frame satisfies the accelerated adjustment determining condition, accelerated adjustment is performed on the prior misadjustment energy in the current time frame; or when the prior misadjustment energy in the current time frame satisfies the decelerated adjustment determining condition, decelerated adjustment is performed on the prior misadjustment energy in the current time frame.

The accelerated adjustment determining condition is generated based on the minimum value of the theoretical prior misadjustment energy range. For example, the accelerated adjustment determining condition may be that a ratio of the minimum value of the theoretical prior misadjustment energy range in the current time frame to the prior misadjustment energy in the current time frame is less than a preset threshold. Alternatively, the accelerated adjustment determining condition may be that the prior misadjustment energy in the current time frame is less than the minimum value of the theoretical prior misadjustment energy range in the current time frame. The decelerated adjustment determining condition is generated based on the maximum value of the theoretical prior misadjustment energy range. For example, the decelerated adjustment determining condition may be that the prior misadjustment energy in the current time frame is greater than the maximum value of the theoretical prior misadjustment energy range in the current time frame.

Optionally, decelerated adjustment is performed on the prior misadjustment energy in the current time frame when the prior misadjustment energy in the current time frame is greater than the maximum value of the theoretical prior misadjustment energy range in the current time frame; or accelerated adjustment is performed on the prior misadjustment energy in the current time frame when a ratio of the minimum value of the theoretical prior misadjustment energy range in the current time frame to the prior misadjustment energy in the current time frame is less than the preset threshold.

The accelerated adjustment is implemented by increasing the prior misadjustment energy, and the decelerated adjustment is implemented by reducing the prior misadjustment energy. An adjustment amount of the accelerated adjustment and an adjustment amount of the decelerated adjustment are determined based on the misadjustment change energy in the current time frame. An acceleration coefficient and a deceleration coefficient are set for the accelerated adjustment and the decelerated adjustment, respectively. Accordingly, the adjustment amount of the accelerated adjustment is determined based on a product of the misadjustment change energy in the current time frame and the acceleration coefficient, and the adjustment amount of the decelerated adjustment is determined based on a product of the misadjustment change energy in the current time frame and the deceleration coefficient.

For example, an accelerated adjustment process of the prior misadjustment energy in the current time frame may be as follows:

$${R}_{m} ( n , k ) = \{ \begin{matrix}{R}_{m} ( n , k ) + speed1 * {R}_{W} ( n , k ) , if quantitle ( n , k ) < d \\ {R}_{m} ( n , k ) , else\end{matrix} ; \\ quantitle ( n , k ) = \frac{{R}_{m} norm ( n , k )}{{R}_{m} ( n , k )}$$

is a ratio of the minimum value of the theoretical prior misadjustment energy range in the current time frame to the prior misadjustment energy in the current time frame. speed1 is the acceleration coefficient; and d is the preset threshold.

For example, a decelerated adjustment process of the prior misadjustment energy in the current time frame may be as follows:

$${R}_{m} ( n , k ) = \{ \begin{matrix}{R}_{m} ( n , k ) + speed2 * {R}_{W} ( n , k ) , if {R}_{m} ( n , k ) > {R}_{m} max ( n , k ) \\ {R}_{m} ( n , k ) , else\end{matrix} ;$$

speed2 is the deceleration coefficient. The acceleration coefficient and the deceleration coefficient may be the same or different. For example, the acceleration coefficient and the deceleration coefficient may each be a value greater than 1.

In this embodiment, the prior misadjustment energy in the current time frame is obtained based on misadjustment change data corresponding to a plurality of time frames, and accelerated/decelerated adjustment is performed on the prior misadjustment energy in the current time frame. This improves a speed at which the prior misadjustment energy approximates to an ideal value, and also avoids a risk of damage to the near-end signal caused by excessively fast convergence. Adjusting the prior misadjustment energy in the current time frame can reduce both the nonlinear problem and the signal damage.

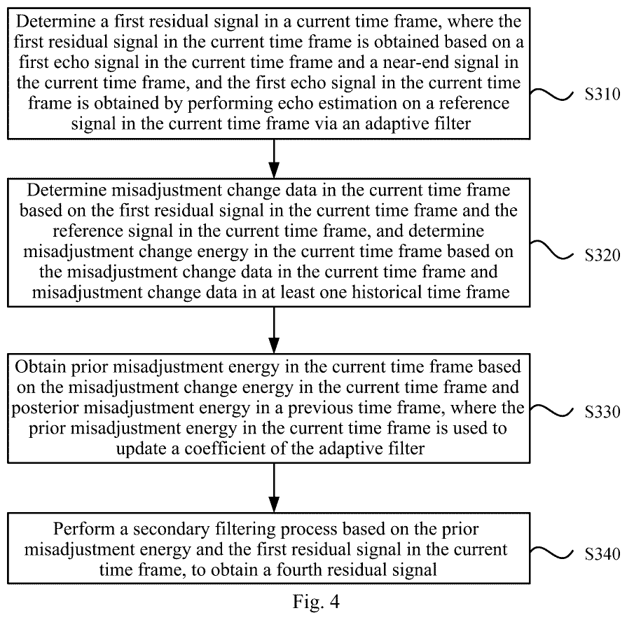

FIG. 4 is a flowchart of an audio processing method according to an embodiment of the present disclosure. On the basis of the above embodiment, a secondary filtering process is performed on the near-end signal, to improve accuracy of an output residual signal. Referring to FIG. 4, the method specifically includes the following steps.
S310: Determining a first residual signal in a current time frame, where the first residual signal in the current time frame is obtained based on a first echo signal in the current time frame and a near-end signal in the current time frame, and the first echo signal in the current time frame is obtained by performing echo estimation on a reference signal in the current time frame via an adaptive filter.
S320: Determining misadjustment change data in the current time frame based on the first residual signal in the current time frame and the reference signal in the current time frame, and determining misadjustment change energy in the current time frame based on the misadjustment change data in the current time frame and misadjustment change data in at least one historical time frame.
S330: Obtaining prior misadjustment energy in the current time frame based on the misadjustment change energy in the current time frame and posterior misadjustment energy in a previous time frame, where the prior misadjustment energy in the current time frame is used to update a coefficient of the adaptive filter.
S340: Performing a secondary filtering process based on the prior misadjustment energy in the current time frame and the first residual signal in the current time frame, to obtain a fourth residual signal.

The near-end signal is filtered in a primary filtering process based on a coefficient of the adaptive filter in the previous time frame, and there is a specific filtering error. In order to improve a signal-to-echo ratio of a linear filter output, secondary filtering is performed on the near-end signal, to obtain a smaller residual signal.

In some embodiments, the coefficient of the adaptive filter is updated based on the prior misadjustment energy in the current time frame and the first residual signal in the current time frame, to obtain a coefficient of the adaptive filter in the current time frame, and the secondary filtering process is performed on the near-end signal based on the updated coefficient of the adaptive filter.

A first reference signal is E(n, k)=D(n, k)−X^{T}(n, k)Ĥ*(n−1, k).

For example, the secondary filtering process may be as follows:

$${R}_{e} ( n , k ) = {X}^{H} ( n , k ) {R}_{m} ( n , k ) X ( n , k ) + {\hat{σ}}_{v}^{2} ( n , k ) ; \\ K ( n , k ) = {R}_{m} ( n , k ) {X ( n , k ) [ {R}_{e} ( n , k ) ]}^{- 1} ; \\ \hat{H} ( n , k ) = \hat{H} ( n - 1 , k ) + K ( n , k ) {E}^{*} ( n , k ) ; \\ and \\ {E}_{out} ( n , k ) = D ( n , k ) - {X}^{T} ( n , k ) {\hat{H}}^{*} ( n , k ) .$$

Rₘ(n, k) is the prior misadjustment energy in the current time frame. Ĥ(n, k) is the coefficient of the adaptive filter in the current time frame. Eₒᵤₜ(n, k) is the fourth residual signal obtained through the secondary filtering process.

It should be noted that a solution matrix may be partitioned in the secondary filtering process, to reduce a computational amount. Details are not described herein.

It can be understood that the computational amount in the secondary filtering process is still large even if the solution matrix is partitioned. In order to further reduce the computational amount and simplify the filtering process, the secondary filtering process is derived. It can be learned that Eₒᵤₜ(n, k)=D(n, k)−X^{T}(n, k)Ĥ*(n, k), where

$${E}_{out} ( n , k ) = D ( n , k ) - {X}^{T} ( n , k ) {\hat{H}}^{*} ( n - 1 , k ) - {X}^{T} ( n , k ) K ( n , k ) {E}^{*} ( n , k ) ; \\ {R}_{e} ( n , k ) = {X}^{H} ( n , k ) {R}_{m} ( n , k ) X ( n , k ) + {\hat{σ}}_{v}^{2} ( n , k ) ; \\ {E}_{out} ( n , k ) = E ( n , k ) - {R}_{m} ( n , k ) {X}^{H} ( n , k ) {X ( n , k ) [ {R}_{e} ( n , k ) ]}^{- 1} E ( n , k ) ; \\ {E}_{out} ( n , k ) = ( 1 - \frac{{R}_{m} ( n , k ) {X}^{H} ( n , k ) X ( n , k )}{{R}_{e} ( n , k )} ) E ( n , k ) ; \\ and \\ {E}_{out} ( n , k ) = \frac{{\hat{σ}}_{v}^{2} ( n , k )}{{R}_{e} ( n , k )} E ( n , k ) .$$

Rₑ(n, k) is near-end energy in the current time frame.

$${\hat{σ}}_{v}^{2} ( n , k )$$

is interference signal energy in the current time frame. Here, the interference signal energy may be understood as Sv(n, k) in the above embodiment, and is calculated based on an estimated interference signal. It can be learned from the above derivation process that the fourth residual signal obtained through secondary filtering is obtained based on the near-end energy in the current time frame, posterior misadjustment change energy in the current time frame, and the first residual signal, without a need for performing a re-filtering process via the adaptive filter, so that the secondary filtering process is simplified, and the computational amount is reduced.

Optionally, the performing a secondary filtering process based on the prior misadjustment energy in the current time frame and the first residual signal in the current time frame, to obtain a fourth residual signal includes: determining the near-end energy in the current time frame based on the prior misadjustment energy in the current time frame and the reference signal in the current time frame; and adjusting the first residual signal in the current time frame based on the near-end energy in the current time frame and the posterior misadjustment change energy in the current time frame, to obtain the fourth residual signal.

It can be understood that, in order to avoid excessively fast convergence of the adaptive filter, a theoretical prior misadjustment energy range of the prior misadjustment energy in the current time frame is set. The prior misadjustment energy in the current time frame is judged based on the theoretical prior misadjustment energy range before the near-end energy in the current time frame is determined. The prior misadjustment energy in the current time frame is updated to a maximum value of the theoretical prior misadjustment energy range if the prior misadjustment energy in the current time frame exceeds the maximum value of the theoretical prior misadjustment energy range.

For example, the near-end energy in the current time frame may be calculated according to the following formula:

$${R}_{e} ( n , k ) = \{ \begin{matrix}{X}^{H} ( n , k ) {R}_{m} max ( n , k ) X ( n , k ) + {\hat{σ}}_{v}^{2} ( n , k ) , if {R}_{m} ( n , k ) > {R}_{m} max ( n , k ) \\ {X}^{H} ( n , k ) {R}_{m} ( n , k ) X ( n , k ) + {\hat{σ}}_{v}^{2} ( n , k ) , else\end{matrix} .$$

According to the technical solution of this embodiment, the secondary filtering process is performed on the near-end signal, to improve the accuracy of the output residual signal. In addition, the secondary filtering process is simplified, and the computational amount for secondary filtering is reduced.

On the basis of the above embodiments, an embodiment of the present disclosure further provides a preferred example of the audio processing method. The method specifically includes the following steps.
Step 1: Initializing a parameter of an adaptive filter, where the parameter of the adaptive filter includes prior misadjustment energy R_{μ}, posterior misadjustment energy Rₘ, a coefficient gain K, a coefficient H of the adaptive filter, interference signal energy \hat{σ}ᵥ², and misadjustment change energy \hat{σ}_{W}².
Step 2: Filtering a near-end signal based on the adaptive filter and a shadow filter, to obtain a residual signal, where a first residual signal is E(n, k)=D(n, k)−X^{T}(n, k)Ĥ*(n−1, k), and a second residual signal is E_{shadow}(n, k)=D(n, k)−X^{T}(n, k)Ĥ*_{shadow}(n−1, k).
Step 3: Judging the first residual signal and the second residual signal, to update the first residual signal:

$$E ( n , k ) = \{ \begin{matrix}{E}_{shadow} ( n , k ) , if E ( n , k ) > a * {E}_{shadow} ( n , k ) \\ E ( n , k ) , else\end{matrix} ;$$

and updating the coefficient of the adaptive filter and a coefficient of the shadow filter:

$$\hat{H} ( n - 1 , k ) = {\hat{H}}_{shadow} ( n - 1 , k ) , if E ( n , k ) > a * {E}_{shadow} ( n , k ) ; \\ and \\ {\hat{H}}_{sha dow} ( n - 1 , k ) = \hat{H} ( n - 1 , k ) , else .$$

Step 4: Filtering the near-end signal via a backup filter, to obtain a third residual signal:

$${E}_{backup} ( n , k ) = D ( n , k ) - {X}^{T} ( n , k ) {\hat{H}}_{backup}^{*} ( n - 1 , k ) ;$$

judging the third residual signal and the first residual signal, to determine whether to start the backup filter, and updating the first residual signal:

$$E ( n , k ) = \{ \begin{matrix}{E}_{backdrop} ( n , k ) , if E ( n , k ) < D ( n , k ) and {E}_{backdrop} ( n , k ) < b * D ( n , k ) \\ E ( n , k ) , else\end{matrix} ;$$

and updating the adaptive filter and the backup filter:

$$\hat{H} ( n - 1 , k ) = {\hat{H}}_{backup} ( n - 1 , k ) , if E ( n , k ) > c * {E}_{backup} ( n , k ) ; \\ and \\ {\hat{H}}_{backup} ( n - 1 , k ) = \hat{H} ( n - 1 , k ) , if E ( n , k ) < b * D ( n , k ) .$$

Step 5: Determining misadjustment change energy in a current time frame based on misadjustment change data in a plurality of time frames, where a solution matrix is partitioned in this process through the following process:

$${R}_{m} ( n , k , l ) = {R}_{μ} ( n - 1 , k , l ) + {R}_{W} ( n - 1 , k , l ) ; \\ {R}_{e} ( n , k ) = {\sum }_{l = 0}^{b} {X}^{H} ( n , k , l ) {R}_{m} ( n , k , l ) X ( n , k , l ) + {\hat{σ}}_{v}^{2} ( n , k ) ; \\ u ( n , k , l ) = \frac{{R}_{m} ( n , k , l )}{{R}_{e} ( n , k )} ; \\ w ( n , k , l ) = {\sum }_{l = 0}^{b} \sum u ( n , k , l ) * conj ( E ( n , k ) ) * X ( n , k , l ) ; \\ {R}_{w} ( n , k , l ) = {\vert w ( n , k , l ) + w ( n - 1 , k , l ) \vert}^{2} ; \\ and \\ {R}_{m} ( n , k , l ) = {R}_{μ} ( n - 1 , k , l ) + {R}_{W} ( n , k , l ) .$$

Step 6: Performing acceleration/deceleration judgment on the misadjustment change energy in the current time frame, and accelerating/decelerating the misadjustment change energy in the current time frame based on a judgment result through the following process:

$${R}_{m} ( n , k ) = \{ \begin{matrix}{R}_{m} ( n , k ) + speed1 * {R}_{W} ( n , k ) , if quantitle ( n , k ) < d \\ {R}_{m} ( n , k ) , else\end{matrix} ; \\ and \\ {R}_{m} ( n , k ) = \{ \begin{matrix}{R}_{m} ( n , k ) + speed2 * {R}_{W} ( n , k ) , if {R}_{m} ( n , k ) > {R}_{m} max ( n , k ) \\ {R}_{m} ( n , k ) , else\end{matrix} .$$

Step 7: Updating the adaptive filter based on adjusted misadjustment change energy in the current time frame:

$${R}_{e} ( n , k , l ) = {\sum }_{l = 0}^{b} {X}^{H} ( n , k , l ) {R}_{m} ( n , k , l ) X ( n , k , l ) + {\hat{σ}}_{v}^{2} ( n , k ) ; \\ u ( n , k , l ) = \frac{{R}_{m} ( n , k , l )}{{R}_{e} ( n , k )} ; \\ K ( n , k , l ) = u ( n , k , l ) X ( n , k , l ) ; \\ \hat{H} ( n , k ) = \hat{H} ( n - 1 , k ) + {\sum }_{l = 0}^{b} K ( n , k , l ) {E}^{*} ( n , k ) ; \\ {R}_{μ} ( n , k , l ) = [ 1 - \frac{u ( n , k , l ) {X}^{H} ( n , k , l ) * X ( n , k , l )}{BLOCKL} ] {R}_{m} ( n , k , l ) ; \\ and \\ {R}_{W} ( n , k , l ) = \frac{{\sum }_{l = 0}^{b} K ( n , k , l ) {E}^{*} ( n , k )}{BLOCKL} .$$

Step 8: Performing secondary filtering:

$${R}_{e} ( n , k ) = \{ \begin{matrix}\begin{matrix}{\sum }_{l = 0}^{b} {X}^{H} ( n , k , l ) {R}_{m} max ( n , k , l ) X ( n , k , l ) + {\hat{σ}}_{v}^{2} ( n , k ) , \\ if {R}_{m} ( n , k ) > {R}_{m} max ( n , k )\end{matrix} \\ {\sum }_{l = 0}^{b} {X}^{H} ( n , k , l ) {R}_{m} ( n , k , l ) X ( n , k , l ) + {\hat{σ}}_{v}^{2} ( n , k ) , else\end{matrix} ; \\ and \\ {E}_{out} ( n , k ) = \frac{{\hat{σ}}_{v}^{2} ( n , k )}{{R}_{e} ( n , k )} E ( n , k ) .$$

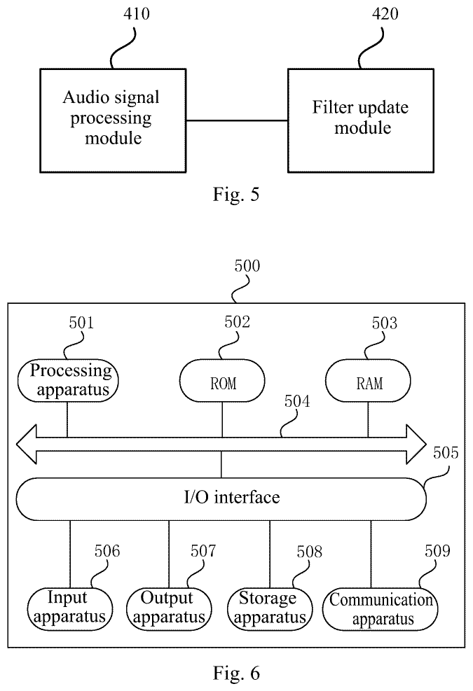

FIG. 5 is a schematic diagram of a structure of an audio processing apparatus according to an embodiment of the present disclosure. As shown in FIG. 5, the apparatus includes an audio signal processing module 410 and a filter update module 420.

The audio signal processing module 410 is configured to determine a first residual signal in a current time frame, where the first residual signal in the current time frame is obtained based on a first echo signal in the current time frame and a near-end signal in the current time frame, and the first echo signal in the current time frame is obtained by performing echo estimation on a reference signal in the current time frame via an adaptive filter.

The filter update module 420 is configured to determine misadjustment change data in the current time frame based on the first residual signal in the current time frame and the reference signal in the current time frame, determine misadjustment change energy in the current time frame based on the misadjustment change data in the current time frame and misadjustment change data in at least one historical time frame, and obtain prior misadjustment energy in the current time frame based on the misadjustment change energy in the current time frame and posterior misadjustment energy in a previous time frame, where the prior misadjustment energy in the current time frame is used to update a coefficient of the adaptive filter.

According to the technical solution according to this embodiment of the present disclosure, during an iteration process in each time frame, prior misadjustment energy in the current time frame is obtained through inference based on misadjustment change data in the current time frame and misadjustment change data in a historical time frame. In other words, the prior misadjustment energy in each time frame is obtained through inference based on a path change between the current time frame and the historical time frame, instead of inference based only on a path in the historical time frame. Therefore, the prior misadjustment energy in each time frame is highly accurate. Accordingly, a coefficient of the adaptive filter corresponding to each time frame is obtained through update based on the highly accurate prior misadjustment energy, so that accuracy of the coefficient of the adaptive filter is improved, and audio processing accuracy is further improved.

On the basis of the above embodiment, the filter update module 420 is optionally configured to: determine initial prior misadjustment energy in the current time frame based on the posterior misadjustment energy in the previous time frame and misadjustment change energy in the previous time frame; obtain near-end estimated energy in the current time frame based on the initial prior misadjustment energy in the current time frame and the reference signal in the current time frame; determine a first step size based on the near-end estimated energy in the current time frame and the initial prior misadjustment energy in the current time frame; and determine the misadjustment change data in the current time frame based on the first step size, the first residual signal in the current time frame, and the reference signal in the current time frame.

Optionally, the filter update module 420 is further configured to determine the misadjustment change energy in the current time frame based on a sum of the misadjustment change data in the current time frame and the misadjustment change data in the previous time frame.

On the basis of the above embodiment, the filter update module 420 is further configured to: determine an interference signal in the current time frame based on the reference signal in the current time frame and the first residual signal in the current time frame; determine a theoretical prior misadjustment energy range in the current time frame based on the reference signal in the current time frame, the first residual signal in the current time frame, and the interference signal in the current time frame; determine an adjustment manner for the prior misadjustment energy based on the theoretical prior misadjustment energy range in the current time frame and the prior misadjustment energy in the current time frame; and update the prior misadjustment energy in the current time frame based on the adjustment manner.

Optionally, the filter update module 420 is further configured to: determine an intermediate signal based on correlation data between the reference signal in the current time frame and the first residual signal in the current time frame, and determine the interference signal in the current time frame based on the intermediate signal and the first residual signal in the current time frame.

Optionally, the filter update module 420 is further configured to: determine a maximum value of the theoretical prior misadjustment energy range based on residual signal energy corresponding to the first residual signal in the current time frame and the reference signal in the current time frame; and determine an energy difference between the residual signal energy corresponding to the first residual signal in the current time frame and interference signal energy corresponding to the interference signal in the current time frame, and determine a minimum value of the theoretical prior misadjustment energy range based on the energy difference and the reference signal in the current time frame.

Optionally, the adjustment manner for the prior misadjustment energy includes accelerated adjustment and decelerated adjustment.

The filter update module 420 is further configured to: perform decelerated adjustment on the prior misadjustment energy in the current time frame when the prior misadjustment energy in the current time frame is greater than the maximum value of the theoretical prior misadjustment energy range in the current time frame; or perform accelerated adjustment on the prior misadjustment energy in the current time frame when a ratio of the minimum value of the theoretical prior misadjustment energy range in the current time frame to the prior misadjustment energy in the current time frame is less than a preset threshold.

On the basis of the above embodiment, the filter update module 420 is optionally further configured to: partition a solution matrix during a process of determining the prior misadjustment energy in the current time frame and during a process of updating the coefficient of the adaptive filter.

Based on the above embodiment, the audio signal processing module 410 is optionally further configured to: perform a secondary filtering process based on the prior misadjustment energy in the current time frame and the first residual signal in the current time frame, to obtain a fourth residual signal.

Optionally, the audio signal processing module 410 is further configured to: determine near-end energy in the current time frame based on the prior misadjustment energy in the current time frame and the reference signal in the current time frame; and adjust the first residual signal in the current time frame based on the near-end energy in the current time frame and posterior misadjustment change energy in the current time frame, to obtain the fourth residual signal.

Based on the above embodiment, the audio signal processing module 410 is optionally further configured to: perform echo estimation on the reference signal in the current time frame based on a shadow filter, to obtain a second echo signal in the current time frame, and determine a second residual signal based on the second echo signal in the current time frame and the near-end signal in the current time frame; and update the first residual signal based on the second residual signal when the first residual signal and the second residual signal satisfy a first condition.

Optionally, the filter update module 420 is further configured to: update the coefficient of the adaptive filter based on a coefficient of the shadow filter when the first residual signal and the second residual signal satisfy the first condition; or update a coefficient of the shadow filter based on the coefficient of the adaptive filter when the first residual signal and the second residual signal do not satisfy the first condition.

Optionally, the audio signal processing module 410 is further configured to: perform echo estimation on the reference signal in the current time frame based on a backup filter, to obtain a third echo signal in the current time frame, and determine a third residual signal based on the third echo signal in the current time frame and the near-end signal in the current time frame; and update the first residual signal based on the third residual signal when the first residual signal and the third residual signal satisfy a second condition.

Optionally, the filter update module 420 is further configured to: update the coefficient of the adaptive filter based on a coefficient of the backup filter when the first residual signal and the third residual signal satisfy a third condition; or update a coefficient of the backup filter based on the coefficient of the adaptive filter when the first residual signal satisfies a fourth condition.

The audio processing apparatus according to this embodiment of the present disclosure can perform the audio processing method according to any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the scope of protection of the embodiments of the present disclosure.

FIG. 6 is a schematic diagram of a structure of an electronic device according to an embodiment of the present disclosure. Reference is made to FIG. 6 below, which is a schematic diagram of a structure of an electronic device (such as a terminal device or a server in FIG. 6) 500 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 500 may include a processing apparatus (such as a central processing unit or a graphics processing unit) 501 that may perform a variety of appropriate actions and processing in accordance with a program stored in a read-only memory (ROM) 502 or a program loaded from a storage apparatus 508 into a random-access memory (RAM) 503. The RAM 503 further stores various programs and data required for the operation of the electronic device 500. The processing apparatus 501, the ROM 502, and the RAM 503 are connected to one another through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 6 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 509, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the audio processing method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium having stored thereon a computer program that, when executed by a processor, causes the audio processing method according to the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the hypertext transfer protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:

The above computer-readable medium carries one or more programs that, when executed by the electronic device, cause the electronic device to: determine a first residual signal in a current time frame, where the first residual signal in the current time frame is obtained based on a first echo signal in the current time frame and a near-end signal in the current time frame, and the first echo signal in the current time frame is obtained by performing echo estimation on a reference signal in the current time frame via an adaptive filter; determine misadjustment change data in the current time frame based on the first residual signal in the current time frame and the reference signal in the current time frame, and determine misadjustment change energy in the current time frame based on the misadjustment change data in the current time frame and misadjustment change data in at least one historical time frame; and obtain prior misadjustment energy in the current time frame based on the misadjustment change energy in the current time frame and posterior misadjustment energy in a previous time frame, where the prior misadjustment energy in the current time frame is used to update a coefficient of the adaptive filter.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An audio processing method, comprising:
determining a first residual signal in a current time frame, wherein the first residual signal in the current time frame is obtained based on a first echo signal in the current time frame and a near-end signal in the current time frame, and the first echo signal in the current time frame is obtained by performing echo estimation on a reference signal in the current time frame through an adaptive filter;
determining misadjustment change data in the current time frame based on the first residual signal in the current time frame and the reference signal in the current time frame, and determining misadjustment change energy in the current time frame based on the misadjustment change data in the current time frame and misadjustment change data in at least one historical time frame; and
obtaining prior misadjustment energy in the current time frame based on the misadjustment change energy in the current time frame and posterior misadjustment energy in a previous time frame, wherein the prior misadjustment energy in the current time frame is used to update a coefficient of the adaptive filter.

2. The method according to claim 1, wherein the determining misadjustment change data in the current time frame based on the first residual signal in the current time frame and the reference signal in the current time frame comprises:
determining initial prior misadjustment energy in the current time frame based on the posterior misadjustment energy in the previous time frame and misadjustment change energy in the previous time frame;
obtaining near-end estimated energy in the current time frame based on the initial prior misadjustment energy in the current time frame and the reference signal in the current time frame;
determining a first step size based on the near-end estimated energy in the current time frame and the initial prior misadjustment energy in the current time frame; and
determining the misadjustment change data in the current time frame based on the first step size, the first residual signal in the current time frame, and the reference signal in the current time frame.

3. The method according to claim 1, wherein the determining misadjustment change energy in the current time frame based on the misadjustment change data in the current time frame and misadjustment change data in at least one historical time frame comprises:
determining the misadjustment change energy in the current time frame based on a sum of the misadjustment change data in the current time frame and misadjustment change data in the previous time frame.

4. The method according to claim 1, further comprising:
determining an interference signal in the current time frame based on the reference signal in the current time frame and the first residual signal in the current time frame;
determining a theoretical prior misadjustment energy range in the current time frame based on the reference signal in the current time frame, the first residual signal in the current time frame, and the interference signal in the current time frame;
determining an adjustment manner for the prior misadjustment energy based on the theoretical prior misadjustment energy range in the current time frame and the prior misadjustment energy in the current time frame; and
updating the prior misadjustment energy in the current time frame based on the adjustment manner.

5. The method according to claim 4, wherein the determining an interference signal in the current time frame based on the reference signal in the current time frame and the first residual signal in the current time frame comprises:
determining an intermediate signal based on correlation data between the reference signal in the current time frame and the first residual signal in the current time frame, and determining the interference signal in the current time frame based on the intermediate signal and the first residual signal in the current time frame.

6. The method according to claim 4, wherein the determining a theoretical prior misadjustment energy range in the current time frame based on the reference signal in the current time frame, the first residual signal in the current time frame, and the interference signal in the current time frame comprises:
determining a maximum value of the theoretical prior misadjustment energy range based on residual signal energy corresponding to the first residual signal in the current time frame and the reference signal in the current time frame; and
determining an energy difference between the residual signal energy corresponding to the first residual signal in the current time frame and interference signal energy corresponding to the interference signal in the current time frame, and determining a minimum value of the theoretical prior misadjustment energy range based on the energy difference and the reference signal in the current time frame.

7. The method according to claim 4, wherein the adjustment manner for the prior misadjustment energy comprises accelerated adjustment and decelerated adjustment; and
the determining an adjustment manner for the prior misadjustment energy based on the theoretical prior misadjustment energy range in the current time frame and the prior misadjustment energy in the current time frame comprises:
performing decelerated adjustment on the prior misadjustment energy in the current time frame in response to the prior misadjustment energy in the current time frame being greater than a maximum value of the theoretical prior misadjustment energy range in the current time frame; or
performing accelerated adjustment on the prior misadjustment energy in the current time frame in response to a ratio of a minimum value of the theoretical prior misadjustment energy range in the current time frame to the prior misadjustment energy in the current time frame being less than a preset threshold.

8. The method according to claim 1, wherein during a process of determining the prior misadjustment energy in the current time frame and during a process of updating the coefficient of the adaptive filter, the method further comprises: partitioning a solution matrix.

9. The method according to claim 1, further comprising:
performing a secondary filtering process based on the prior misadjustment energy and the first residual signal in the current time frame, to obtain a fourth residual signal.

10. The method according to claim 9, wherein the performing a secondary filtering process based on the prior misadjustment energy and the first residual signal in the current time frame, to obtain a fourth residual signal comprises:
determining near-end energy in the current time frame based on the prior misadjustment energy in the current time frame and the reference signal in the current time frame; and
adjusting the first residual signal in the current time frame based on the near-end energy in the current time frame and posterior misadjustment change energy in the current time frame, to obtain the fourth residual signal.

11. The method according to claim 1, further comprising:
performing echo estimation on the reference signal in the current time frame based on a shadow filter, to obtain a second echo signal in the current time frame, and determining a second residual signal based on the second echo signal in the current time frame and the near-end signal in the current time frame; and
updating the first residual signal based on the second residual signal in response to the first residual signal and the second residual signal satisfying a first condition.

12. The method according to claim 11, further comprising:
updating the coefficient of the adaptive filter based on a coefficient of the shadow filter in response to the first residual signal and the second residual signal satisfying the first condition; or updating a coefficient of the shadow filter based on the coefficient of the adaptive filter in response to the first residual signal and the second residual signal not satisfying the first condition.

13. The method according to claim 1, further comprising:
performing echo estimation on the reference signal in the current time frame based on a backup filter, to obtain a third echo signal in the current time frame, and determining a third residual signal based on the third echo signal in the current time frame and the near-end signal in the current time frame; and
updating the first residual signal based on the third residual signal in response to the first residual signal and the third residual signal satisfying a second condition.

14. The method according to claim 13, further comprising:
updating the coefficient of the adaptive filter based on a coefficient of the backup filter in response to the first residual signal and the third residual signal satisfying a third condition;
updating the coefficient of the backup filter based on the coefficient of the adaptive filter in response to the first residual signal satisfies a fourth condition.

15. An electronic device, comprising:
one or more processors; and
a storage apparatus configured to store one or more programs, wherein the one or more programs, when executed by the one or more processors, cause the one or more processors to implement an audio processing method, comprising:
determining a first residual signal in a current time frame, wherein the first residual signal in the current time frame is obtained based on a first echo signal in the current time frame and a near-end signal in the current time frame, and the first echo signal in the current time frame is obtained by performing echo estimation on a reference signal in the current time frame through an adaptive filter;
determining misadjustment change data in the current time frame based on the first residual signal in the current time frame and the reference signal in the current time frame, and determining misadjustment change energy in the current time frame based on the misadjustment change data in the current time frame and misadjustment change data in at least one historical time frame; and
obtaining prior misadjustment energy in the current time frame based on the misadjustment change energy in the current time frame and posterior misadjustment energy in a previous time frame, wherein the prior misadjustment energy in the current time frame is used to update a coefficient of the adaptive filter.

16. The electronic device according to claim 15, wherein in the audio processing method,
the determining misadjustment change data in the current time frame based on the first residual signal in the current time frame and the reference signal in the current time frame comprises:
determining initial prior misadjustment energy in the current time frame based on the posterior misadjustment energy in the previous time frame and misadjustment change energy in the previous time frame;
obtaining near-end estimated energy in the current time frame based on the initial prior misadjustment energy in the current time frame and the reference signal in the current time frame;
determining a first step size based on the near-end estimated energy in the current time frame and the initial prior misadjustment energy in the current time frame; and
determining the misadjustment change data in the current time frame based on the first step size, the first residual signal in the current time frame, and the reference signal in the current time frame.

17. The electronic device according to claim 15, wherein in the audio processing method,
the determining misadjustment change energy in the current time frame based on the misadjustment change data in the current time frame and misadjustment change data in at least one historical time frame comprises:
determining the misadjustment change energy in the current time frame based on a sum of the misadjustment change data in the current time frame and misadjustment change data in the previous time frame.

18. The electronic device according to claim 15, wherein the audio processing method further comprises:
determining an interference signal in the current time frame based on the reference signal in the current time frame and the first residual signal in the current time frame;
determining a theoretical prior misadjustment energy range in the current time frame based on the reference signal in the current time frame, the first residual signal in the current time frame, and the interference signal in the current time frame;
determining an adjustment manner for the prior misadjustment energy based on the theoretical prior misadjustment energy range in the current time frame and the prior misadjustment energy in the current time frame; and
updating the prior misadjustment energy in the current time frame based on the adjustment manner.

19. The electronic device according to claim 18, wherein in the audio processing method,
the determining an interference signal in the current time frame based on the reference signal in the current time frame and the first residual signal in the current time frame comprises:
determining an intermediate signal based on correlation data between the reference signal in the current time frame and the first residual signal in the current time frame, and determining the interference signal in the current time frame based on the intermediate signal and the first residual signal in the current time frame.

20. A non-transient storage medium comprising computer-executable instructions, wherein the computer-executable instructions, when executed by a computer processor, are configured to:
determine a first residual signal in a current time frame, wherein the first residual signal in the current time frame is obtained based on a first echo signal in the current time frame and a near-end signal in the current time frame, and the first echo signal in the current time frame is obtained by performing echo estimation on a reference signal in the current time frame through an adaptive filter;
determine misadjustment change data in the current time frame based on the first residual signal in the current time frame and the reference signal in the current time frame, and determine misadjustment change energy in the current time frame based on the misadjustment change data in the current time frame and misadjustment change data in at least one historical time frame; and
obtain prior misadjustment energy in the current time frame based on the misadjustment change energy in the current time frame and posterior misadjustment energy in a previous time frame, wherein the prior misadjustment energy in the current time frame is used to update a coefficient of the adaptive filter.
